(19) United States
(12) Patent Application Publication
(10) Pub. No.: US 2017/0220967 A1
(43) Pub. Date: Aug. 3, 2017

(54) FRAMEWORKS AND METHODOLOGIES CONFIGURED TO IMPLEMENT RISK MANAGEMENT FUNCTIONALITIES VIA ORGANISED ACTIVITY PLANNING SOFTWARE

(71) Applicant: COMPLISPACE TECHNOLOGY PTY LTD, Sydney, New South Wales (AU)

(72) Inventor: James David FIELD, Fairlight (AU)

(73) Assignee: COMPLISPACE TECHNOLOGY PTY LTD, Sydney, New South Wales (AU)

(21) Appl. No.: 15/124,294

(22) PCT Filed: Mar. 6, 2015
(86) PCT No.: PCT/AU2015/000128

§ 371 Date: Sep. 7, 2016

(30) Foreign Application Priority Data
Mar. 7, 2014 (AU) 2014900769

(51) Int. Cl. G06Q 10/06; G06Q 50/20

(52) U.S. Cl. CPC G06Q 10/06311; G06Q 10/0635; G06Q 50/205

(57) ABSTRACT

The technology described herein relates to frameworks and methodologies configured to provide organised activity management functionalities. Embodiments of the invention have been particularly developed primarily to assist in managing risk and compliance issues for organised activities where an organiser owes a duty of care towards participants, for example school excursions. While some embodiments will be described herein with particular reference to that application, it will be appreciated that the invention is not limited to such a field of use, and is applicable in broader contexts.

### FIELD OF THE INVENTION

The present invention relates to frameworks and methodologies configured to provide risk management functionalities, particularly in the context of organised activity planning software. Embodiments of the invention have been particularly developed primarily to assist in managing risk and compliance issues for organised activity where an organiser has a duty of care towards participants, particularly school excursions, incursions, field trips, day trips, treks, expeditions, safaris, tours, fairs, fetes, events and the like. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

The management of organised activities is a major risk for schools and other education providers, tour operators, age care and health care providers and creates numerous administrative challenges for staff. The management and administration of organised activities is in fact often a point of conflict between activity leaders (who simply want to ensure participants gain the experiences that organised activity the activity offers) and administrators (whose job it is to manage risk and ensure compliance).

### SUMMARY OF THE INVENTION

It is an object of the present invention to overcome or ameliorate at least one of the disadvantages of the prior art, or to provide a useful alternative.

One embodiment provides a computer implemented method for enabling management of organised activities, the method including:

providing a user interface that enables a user to generate an organised activity record for a proposed organised activity;

enabling the user to access a repository of organised activity items, wherein at least a selection of the organised activity items are each associated with data indicative of risk management policy data;

enabling the user to associate one or more of the organised activity items with the organised activity record; and

providing an interface that allows a further user to view the organised activity record, and thereby view the risk management policy data for the one or more organised activity items associated with the organised activity record.

One embodiment provides a computer implemented method wherein each of the one or more organised activity items associated with the organised activity record are associated with supervisor guideline data, and wherein the method include outputting a representation of the supervisor guideline data for the organised activity record thereby to assist an organised activity supervisor in implementing risk management policies of the risk management policy data during the organised activity.

One embodiment provides a computer implemented method wherein the representation includes one or more checklists.

One embodiment provides a computer implemented method wherein the repository of organised activity items includes items customised from templates.

One embodiment provides a computer implemented method wherein the repository of organised activity items includes items representing services, activities and/or venues provided by a service provider, wherein those items customised from templates by or on behalf of the service provider.

One embodiment provides a computer implemented method wherein the organised activity items include organised activity items representing participants for the proposed organised activity.

One embodiment provides a computer implemented method wherein an organised activity items for a given participant includes risk management policy data for a medical condition associated with the given participant.

One embodiment provides a computer implemented method including providing a service provider interface configured to allow a service provider to generate and/or modify one or more organised activity items, where the generate and/or modified items are stored in the repository.

One embodiment provides a computer implemented method including enabling the user to initiate a permission approval request process, thereby to provide data indicative of the organised activity records to addresses associated with participant guardians.

One embodiment provides a computer implemented method wherein the method includes receiving and processing responses from the participant guardians thereby to maintain a record of received permission approvals.

One embodiment provides a computer implemented method for enabling management of organised activities, the method including:

(i) providing an application interface that is configured to enable the generation of a new organised activity application;

(ii) maintaining an organised activity register that provides access to an organised activity space for each of a plurality of organised activity records, wherein an organised activity record is generated responsive to a new organised activity application generated via the application interface;

(iii) via the organised activity space, providing access to complete an organised activity workflow process, wherein the organised activity workflow process is defined by a plurality of interactive sub-processes.

One embodiment provides a computer implemented method for enabling management of participant organised activities, the method including:

(i) providing an interface that is accessible by a plurality of user categories;

(ii) maintaining an organised activity register that provides access to an organised activity space for each of a plurality of organised activity records, wherein an organised activity record is generated responsive to a new organised activity application generated via the application interface;

(iii) via the organised activity space, providing access to complete an organised activity workflow process, wherein the organised activity workflow process is defined by a plurality of interactive sub-processes, including one or more sub-processes respectively configured to be conducted by users of each of the plurality of user categories.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A schematically illustrates a framework according to one embodiment.

FIG. 1B schematically illustrates a framework according to one embodiment.

FIG. 2 illustrates a method according to one embodiment.

FIG. 3 illustrates a client-server framework leveraged by various embodiments.

FIG. 4A to FIG. 4O illustrate screenshots according to an exemplary embodiment.

### DETAILED DESCRIPTION

The present invention relates to frameworks and methodologies configured to provide organised activity management functionalities. Embodiments of the invention have been particularly developed primarily to assist in managing risk and compliance issues for organised activities where an organiser owes a duty of care towards participants, for example school excursions. While some embodiments will be described herein with particular reference to that application, it will be appreciated that the invention is not limited to such a field of use, and is applicable in broader contexts.

The term “organised activity” as used herein refers to an organised event where a group of persons engage in an activity that or organised by an organiser. The organiser owes a duty of care towards the participants, and hence should (or is required to) engage in a form of risk management in respect of the organised activity. The term “organised activity” has various corresponding terms used across various jurisdictions and in varying settings. For example, in the United States, a more common term is “field trip”.

It will be appreciated that, in spite of continued references to the term “organised activity”, it will be appreciated that the technology is applicable to various events, including other events which correspond to those falling under the term “organised activity” (such as excursions, field trips, site visits, school camps, tours and so on) and other events where there is a desire to perform risk management in light of a duty of care towards participants. In relation to the latter, one example is an “incursion”, which shares certain similarities with an “excursion” (for example participants and risks to be managed) but occurs on a site where the participants are already located. For example, this is common in schools, where an event is organised for participants which involves performers or the like visiting school grounds.

### Overview

Various embodiments provide computer implemented methods for enabling management of organised activities, such as student excursions (as noted above, also known as field trips). For example, these methods may be provided via one or more software applications, in some cases being provided in the context of a web-based (“cloud-hosted”) implementation whereby a plurality of users access functionalities via web browsers executing on respective client terminals.

Some embodiments provide technology whereby a software tool allows a user to plan an organised activity whilst inherently (but indirectly) performing risk management actions. This is achieved by providing data repositories of “organised activity items”, which represent individual components of an organised activity. For example, organised activity items may relate to transportation, accommodation, visitation sites, and so on. The organised activity items are preferably each associated with predefined risk management policies (which detail how risk is being, and/or is to be managed for that item), and with organised activity supervisor guideline data (for example in the form of one or more checklists) which is used by an organised activity supervisor during the organised activity to assist in implementation of the risk management policy. Hence, in an example, a teacher is able to piece together a proposed organised activity by selecting required organised activity items, and as a result of that process: review risks and risk management policies for the selected items; and generate a checklist of risk management procedures to be implemented during the organised activity itself.

The organised activity items may include a range of resources relating to a proposed organised activity. In some embodiments, this includes participants. Each participant may be associated with individual risk management data (for example in relation to known medical conditions) hence automating a process whereby risk management data is organised for a proposed organised activity by reference to nuances of the individual participants.

In some embodiments, the software provides an application interface (for example via browser rendered objects) that is configured to enable the generation of a new organised activity application. In a preferred embodiment user interacts with this interface thereby to perform functionalities including:
Generating a new organised activity record.
Modifying a previously commenced organised activity record.
Reviewing one or more existing organised activity records (for example an organised activity record generated by another user).
Managing participant permission approvals (for example causing permission approval notifications to be generated, and reviewing responses to such requests).
Viewing risk management policies and ratings associated with organised activity records.
Viewing and obtaining risk management checklists associated with a given organised activity record.

In some embodiments web-based software interface is provided, whereby each user navigates to a predefined URL, and provides credentials thereby to access user interface components, which are downloaded from a server component and rendered in the local web browser thereby to provide access to functionalities and information available via the server. In some embodiments such a browser-based approach is replaced by, or supplemented with, proprietary software (for example mobile apps), thereby to provide an alternate means for delivering an appropriate user interface.

The software additionally maintains an organised activity space (which may be defined from a physical perspective by one or more databases and/or data tables, and/or software modules that provide functional access to information contacted therein). The organised activity space provides users with access to a plurality of the organised activity records. Such access is controlled by reference to user credentials (for example in the context of which organised activity records are accessible, and the manner in which those organised activity records are available). For example each organised activity record is accessible via the organised activity space by a plurality of users, wherein each user has a user category and a user permission set. The user categories may include one or more of teachers, administration staff, guardians, students and/or third parties.

The organised activity space provides access to users thereby to enable completion of an organised activity workflow process. The organised activity workflow process is defined by a plurality of interactive sub-processes. The plurality of interactive sub-processes in some embodiments include one or more sub-processes that are configured to be completed by a first category of user, and one or more sub-processes that are configured to be completed by a second category of user. For example, the sub-processes may include sub processes which involve interaction from teacher users, administrative staff users, guardian users, and so on. Upon accessing a given organised activity record via the organised activity space, is provided with access to functionalities and/or information responsive to the user's user category and user permission set.

### First Exemplary Framework

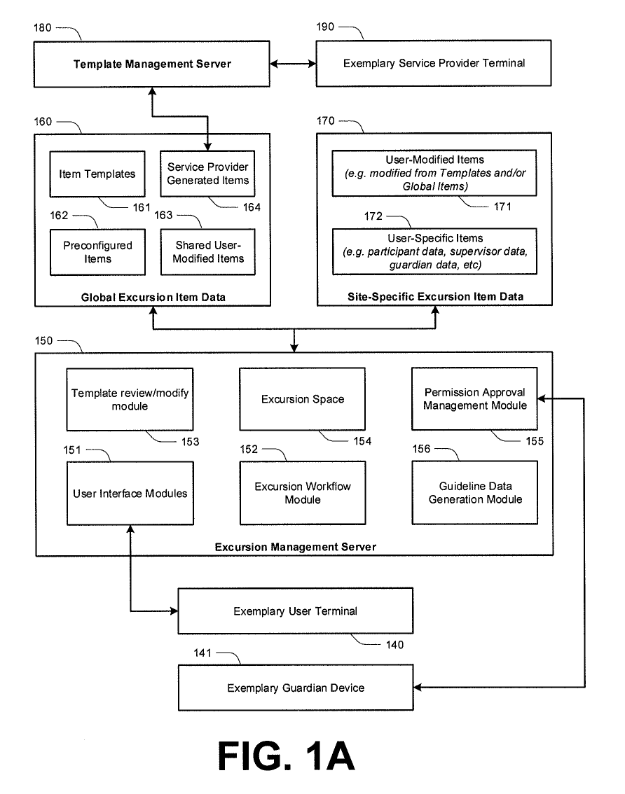

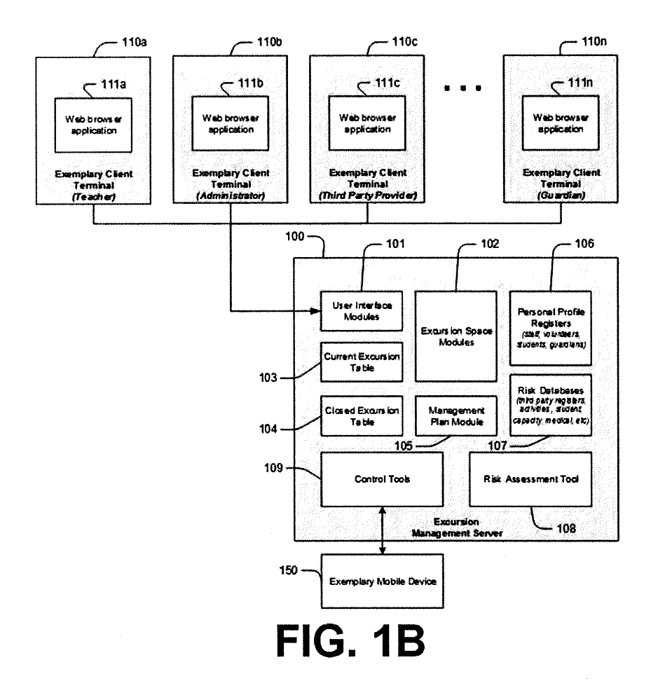

FIG. 1A illustrates an exemplary embodiment whereby the software is delivered via an organised activity management server 150. In this example, server 150 is illustrated as a site-specific server (for example specific to an individual school). However, it should be appreciated that server 150 in some embodiments provides organised activity management software for a plurality of sites (for example a plurality of schools) via common server side infrastructure (although with each site having unique access permissions to access data relating specifically to that site).

Server 150 provides user interface module 151, which enable a user to render, at an exemplary user terminal 140, a user interface. For example, the user interface is rendered within a web browser. Exemplary user terminal 140 may be operated by a range of users, with each user having respective access credentials to enable access to (and identification by) server 150. Users may include persons responsible for organising organised activities (for example teachers) and users responsible for reviewing proposed organised activities, for example to assess risk management issues (for example school administrators).

Server 150 provides an organised activity workflow module, which allows a user to generate and modify organised activity records, and perform other actions relating to organised activity records. Organised activity records are maintained in an organised activity space 154.

Organised activities are generated by a process that includes the user selecting organised activity items that are added to an organised activity record in the organised activity space. In the example of FIG. 1A, organised activity items are selected from a repository of global organised activity item data 160, and a repository of local organised activity item data 170. There are, in some embodiments, maintained in a common data store and distinguished at a contextual level. In that regard, data 160 is available to multiple different sites (for example schools) that implement the organised activity management software, whereas data 170 is site-specific (for example organised activity items generated from a template by a user at a given site, customised for that site, and not to be shared with other sites). The user interface provides functions such as search functions, filters and the like to assist a user in identifying relevant/desired organised activity items.

Global organised activity item data 160 includes item templates 160. These are partially generated items, which are able to be accessed by a user and modified. The templates are preferably specific to item categories, for example “accommodation”, “transportation”, “museums”, “theatres”, and so on. More preferably, they are defined at a greater level of specificity, for example transportation items including “coach transportation” and “bus transportation”.

Each item template is preferably pre-associated with risk management data, including risk management policy data, and supervisor guideline data. A user, via template review/modify module 153, is enabled to access a template, and customise it for a specific purpose thereby to generate a new organised activity item (which is stored in either shared user modified items 163, or non-shared user-modified items 171). The customisation process may include working through a due diligence process (which is preferably performed with assistance from stepwise instructions from server 150). For example, in the context of a coach transportation item, a user performs due diligence by ensuring a specific desired coach operator meets necessary safety standards, adheres to relevant requirements, and so on. Once the due diligence is completed, the resulting modified organised activity item is able to be re-used for subsequent organised activity records (hence due diligence is conducted as a one-off).

Vendor generated items 164 are also generated from item templates 161, but these are generated by service providers (for example, continuing the example above, a coach operator) who wish for users of server 150 to have convenient access to their services. That is, the service provider generates an organised activity items that satisfies predefined due diligence requirements, hence allowing a user to add that item to an organised activity record with minimal or no customisation. It will be appreciated that this provides service providers with an ability to market their services for the purpose of organised activities. In the example of FIG. 1A, a service provider uses an exemplary service provider terminal 190 to access a template management server 180 which provides a service provider interface, thereby to generate service provider generated items 164 (for example using item templates 161).

Preconfigured items 162 are generated by an administrator associated with server 150. These are preferably defined for a range of common organised activity items, including various types of basic transportation (for example suburban walking and city walking), sports and activities (for example baseball, soccer, archery) and so on. These differ from item templates in the sense that due diligence is generally not required.

In the same manner as item templates 161, a user is enabled to customise preconfigured items 162, service provider generated items 164, and shared user modified items 163.

In some embodiments organised activity items (and more specifically risk management policy data and guideline data) is defined on a jurisdiction-by-jurisdiction basis, noting local laws, regulations, and independently defined guidelines.

Site specific organised activity item data 170 includes user specific items 172, which includes the likes of participant data (e.g. for individual students), supervisor data, guardian data, contact data, and so on. This is in some embodiments extracted from third party pre-existing databases in an automated or semi-automated fashion using an API.

The site specific item data enables a user to add participants (e.g. students) to an organised activity. This preferably results in either or both of the following:
Automated generation of risk management policy data and/or guideline data in the organised activity space based on characteristics associated with the individual participants (for example medical conditions). For example, in the case that a student is asthmatic, the risk management policy data might indicate that supervisors should know how to handle asthma attacks and carry medications, and the guideline data include a checklist item requiring that a supervisor is carrying the relevant medications.
Ability to initiate a permission approval process, which contacts guardians associated with the participants (for example via email or the like), and invites them to review risk management policy data associated with the organised activity record, and provide an approval.

In the case of the latter, a permission approval management module 155 enables interaction with guardian devices (for example exemplary guardian device 141) thereby to manage that approval process. In some cases a user is enabled to manually input data indicative of guardian approvals (for example where approval is received other than via module 155).

In practice, a user generates a new organised activity record (which may be based upon a previously generated organised activity record) and performs a process that includes adding, removing and/or modifying organised activity items. This allows the user, or another user, to review the organised activity record, its items, and risk management policy data associated with those items. Once the organised activity record is completed, the user gains approvals from guardians via module 155. Then, prior to (or during) the organised activity, guideline data generation module is used to provide output of guideline data to assist an organised activity supervisor in implementing risk management during the actual organised activity. For example, this may be achieved via automatically generated checklists, which are viewed in paper or electronic form. For example, there may be a checklist associated with coach travel, with walking students through a city area, and so on.

### Second Exemplary Framework

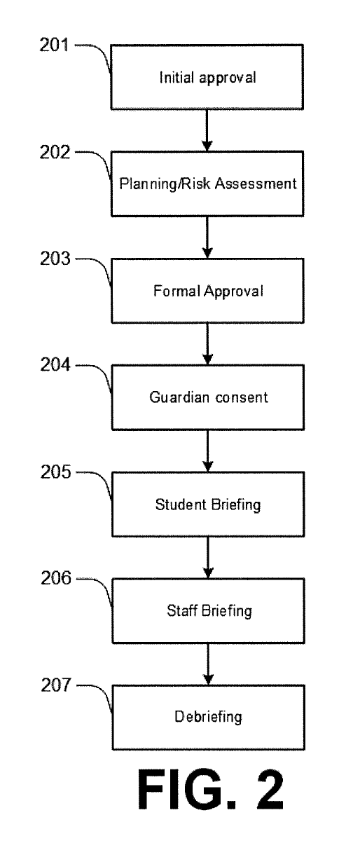

FIG. 1B illustrates a further exemplary embodiment whereby the software is delivered via an organised activity management server 100. FIG. 2 illustrates an associated exemplary organised activity workflow process. It should be appreciated that various functionalities described by reference to FIG. 1B are in other embodiments provided via the framework of FIG. 1A.

Server 100 is accessed by a plurality of client terminals, such as exemplary client terminals 110a-111n which each execute a respective web browser application 111a-111n. The illustrated client terminals provide an indication of various user categories, including teachers, administrative staff, third parties, and guardians (for example patents and/or carers). These terminals interact with server 100 via user interface component 101.

In this embodiment, each new organised activity is “commenced” (i.e. the planning process is commenced) through an Organised activity Application Form, which is preferably a web-fillable form. Once this is submitted it creates an Organised Activity Record which is accessible via an Organised Activity Space provided through organised activity space modules 102. This is linked through a Current Organised Activity Table 103. If the application is rejected this information is stored with reasons for the rejection and the Organised Activity Record is closed. A number of template application forms are preferably made available (for instance in respect of common categories of organised activity) with a user having the ability to create their own templates.

The Current Organised Activities Table is a central location from which all “current organised activities” (from proposed through to those in debriefing stage) can be viewed and accessed. It is designed to be able to search through filters and the view changed depending the information the user wants to see displayed. It is also from this table that reports is produced (e.g. “all art organised activities conducted over the past 2 years”; “all Year 10 organised activities conducted during the past 12 months”; “all organised activities where Peter Smith was a supervisor”; etc.).

Proposed organised activity dates are able to be displayed through a Calendar view (in some cases being linked to Outlook or other applications such as Google Calendar). This calendar view will have filters which will allow a user to tailor their view according to their individual user profile.

An Organised Activity Space is created for each organised activity and it is through this space that the particular organised activity is managed, for example following application to an Initial Approval sub-process through to a Debriefing sub-process. The Organised activity space is dynamic and configurable allowing staff to collaborate on the project. Once contact details are uploaded the Organised Activity Space is used as the primary communication platform for the organised activity.

Some of the key features of the Organised Activity Space are:

School staff (and volunteers who may be attending the organised activity in a supervisory capacity) will have access to information in the space in accordance with their security profile).

From the space activity leaders are able to “share information” with others (including staff, students and parents/carers who are linked to the space) via email groups, SMS or other commercially available medium. This avoids external email groups and ensures that all information/communications relevant to the organised activity are captured in one location.

Profiles of all supervisors are available with details of relevant experience (e.g. first aid, specific activity supervision qualifications). These profiles are maintained in a separate database (Point 9) so that they can be maintained in, and sourced from, one location. The creation of separate registers for staff, students & parents will avoid having to repeat entering the individual's profile for each organised activity.

The profiles of all participants/parents/guardians in the target participant group (e.g. Year 10 Art) are linked from the participant profile database (Point 9) to the relevant organised activity space. For curriculum linked organised activities, this will allow a school to record which students should attend and record those students that did and didn't attend (with reasons for non attendance). For optional organised activities (e.g. an overseas trip) this will allow a school to identify a target group (e.g. Years 10-12 are eligible to attend), run a campaign to attract participants, remove all that haven't responded to an initial expression of interest and then narrow down the linked student profiles to those that have actually committed to attend.

Documents relevant to the organised activity can be uploaded and viewed on-line in accordance with a user's security profile.

The organised activity space is designed to follow and accommodate the steps that will normally be undertaken in running an organised activity from Initial Approval, Planning and Risk Assessment, Formal Approval, Parental Consents, Student Briefings, Supervisor Briefing and Post Organised Activity Debriefings (as shown blocks 201-207 of FIG. 2). By way of example parents can provide “Consents” on-line. As the consents come in these would be marked against the students names (Green Tick) so it is easy for staff to identify those parents who had not returned their permissions slips. These are marked with a Red Cross. So as to maintain flexibility in the event that a parent forgets to return the slip a teacher could accept an alternative permission (e.g. a text message) and make a note of it against the students profile within the organised activity space. Similarly supervisor briefing documents can be posted to the Organised Activity Space and each supervisor asked to acknowledge that they have read and understood these documents.

Each Organised Activity Space contains an Organised Activity Management Plan (EMP) that requires approval before the organised activity can proceed. The Organised Activity Management Plan contains all key information in relation to the organised activity including (i) a detailed itinerary (ii) an assessment of key risks, (iii) risk control strategies (iv) risk control measures to be implemented. Organised Activity Management Plan is not designed to be taken on the organised activity rather it is a “planning document” used to ensure key risks are identified and appropriate risk control strategies will implemented effectively before and during the conduct of the organised activity.

A link between the Organised Activity Space and EMP to various risk databases (and personal profile databases) that is key to ensuring ease of use and the avoidance of duplication of effort by teaching staff. Each of the key risk areas: Venue, Accommodation, Food in Transit, Transport, Activities, Student Capability and Student Medical Conditions (more may be added) will have their own Risk Database 107 from which data can be selected to be included in an individual EMP.

This design, with individual databases separated from the Organised Activity Space and EMP, allows a person planning the organised activity to either use information that has already been captured on a database (e.g. the details of a particular venue) or to add new information to a database. By way of example, a teacher could view and link information relating to a Venue used for the past 5 years including comments from previous Organised Activity Leaders. Where the teacher intends to visit a new venue that is not on the school's existing databases they would be prompted to add a new venue to the database, enter relevant due diligence information and make a risk assessment with respect to the venue. In this way a school will capture the details of the venue in one place and avoid duplication for future organised activities because once the relevant venue (or transport company or activity) has been added a risk profile of the venue is created over time.

The system provided via server 100 has an inbuilt Risk Management Tool 108 which allows schools and teachers to assess risks in terms of likelihood and consequence and to apply a risk rating. This can be done both at the Risk Database level and the EMP level.

The system operates using a residual risk methodology which means that the risks are assessed after having taken into consideration the controls that the school will put into place to manage the particular risk. To assist in this process the Database Level Risk Assessments are linked to control libraries allowing teachers to allocate relevant controls to each risk.

Database Level Risk Assessments enable a detailed risk assessment to be undertaken for each activity, venue, transport option etc. within the risk databases. The system provides template risk assessments using common risks associated with each type of event (e.g. the risk profile of a bus company will interrogate things like safety records, driver experience whilst the risk profile of an activity like canoeing will deal with safety gear, swimming ability etc.). Guided by the templates, activity organisers, such as schools, can create their own risk profiles based on the due diligence information that they gather and the controls they will put in place. They also have the option of ignoring the template risks and creating their own set of risks. Based on the analysis of the detailed risk assessment, an activity organiser can then allocate each activity, venue etc. with an overall risk rating (i.e. based on the response to 5 key risk assessments the overall risk to the safety of a child undertaking this activity, travelling with this bus company etc. is “Low” or “Medium”.

Another form of risk assessment is EMP Level Risk Assessments: Whilst each venue, activity, etc. are allocated an overall risk rating at the database level it is important that the particular issues are also reviewed in the context of the particular organised activity that is actually taking place. To enable this to happen, when a teacher selects a particular venue, activity etc. from a database for inclusion in their organised activity they are asked to either confirm the existing overall risk assessment or to allocate a new risk assessment. If they allocate a new risk assessment they will need to provide their reasons for amending the original assessment.

In addition to the EMP level risk assessments that are undertaken based on each venue, activity, transportation option etc. the organised activity itself is provided with an overall risk assessment. By way of example a Year 12 organised activity for 2 hours to a local restaurant a 3 minute walk from a school may have an overall risk rating of “Low”, whilst an overseas organised activity to a third world country with a 2 week duration may have an overall risk rating as “High”.

Based on this design a activity organiser is able to view an organised activity in terms of cascading risk:

Macro Level: Each organised activity will have an overall risk rating.

Mid Level: Each venue, activity etc. is allocated an overall risk rating

Micro Level: Each venue, activity will have been subject to a detailed risk assessment

The system is designed so that the “Macro” and “Mid” level assessments are made based on the data that is drawn from the “Micro” risk assessments whilst simultaneously allowing a teacher the flexibility to consider the overall risk associated with the organised activity.

Against every risk there needs to be a control. The most common controls in school organised activities are the implementation of strategies with respect to due diligence, supervision, communication, known medical conditions, student capabilities, informed consent and critical incident response. There will also be specific controls associated with specific activities. For example, if a school group is going canoeing on a river it is important to check the weather immediately prior to departure. The Risk Controls Library sets out the details of all risk controls which can then be linked to specific risks that have been identified relating to the organised activity.

Whilst some risk controls are attended to prior to the organised activity commencing (e.g. due diligence with respect to the safety of a venue) other risk controls need to be implemented as the organised activity is in progress. Specific Risk Control Tools 109 enable performance of risk controls via an exemplary mobile device 150 (for example a tablet or smartphone device). A simple example is a high level checklist that a teacher may be required to complete immediately before students commence a canoeing trip, such as: “Has the weather been checked?”, “Are all students wearing life jackets”, and so on. These Risk Control Tools may be available on a mobile application such as a mobile phone or as a hard copy check list that could be printed out from the system (in the event that the organised activity is being conducted in a remote area).

Data from key databases such as Personal Details Database 106 for Students, Staff, Volunteers, and Parents are extracted and assigned to the Organised Activities Space. This could be done by class, year group or target market (for overseas tours). As the organised activity planning progresses and the attendees are finalized the information in the Organised Activity Space is updated accordingly. (The process of Adding and Removing people from the Organised Activity Space is very straight forward). This point will also require a strong API. Ideally the data will simply be extracted from a school's existing databases so that it remains current.

Once an organised activity has been completed (after the final debrief) the Organised Activity Space will then be closed. All information with respect to the organised activity will then be placed on the Organised Activities Closed Register where they may be referenced in the future. A key feature of the system is that closed Organised Activity Spaces can be copied to create a new organised activity space. This means that if a teacher wants to do the same organised activity as they did last year they can simply copy the previous year's organised activity space and then allocate people (Staff, Students, Parents) to that space.

Whilst each school will have its own dedicated site, to further aid activity leaders in managing organised activities a secure (subscriber only) preferably is provided thereby to allow multiple activity leaders to locate organised activity friendly third party vendors and immediately access key due diligence information.

From a risk and compliance perspective the main purpose of this site is that any third party vendor that wishes to be included in the site is asked to provide Due Diligence Information (based on a questionnaire designed for the type of service that is being provided) and ensure that this information is up-to-date. If they don't provide the information they can still advertise their services. However are able to filter them out of relevant searches.

By getting vendors to provide legally robust Due Diligence Information will mean that teachers will have readily available access to the key information that they need when creating a new entry on one of their school's Risk Databases (e.g. a new venue, hotel/motel, restaurant, bus company, etc.) or even if they simply want to update information with respect to an existing provider. The information would be available to download so it can be added simply into the individual school's Organised Activity Manager databases ready to be linked to a particular EMP.

Some key features/advantages of School Community Website will be:

Schools looking for new organised activity experiences are able to search the database through a variety of filters (e.g. subject area, activity, location) to find an appropriate vendor.

Third Party Vendors (transportation companies, venues, hotels etc.) are able to promote themselves directly to schools.

Schools are able to narrow down searches by location (e.g. find Spanish Restaurant within 10 km).

Schools are able to rate their organised activity experiences and provide comments that will assist other schools in making their risk assessments.

Third party applications such as Bound Round are able to featured and added to the profile of a vendor giving more information to teachers so that they can make better informed choices of vendors.

Server 100 additionally provides an administration back end allowing administrators to manage key aspects of their sites such as setting up users and security profiles, tailoring content fields and setting preferences. There will also be an on-line help facility.

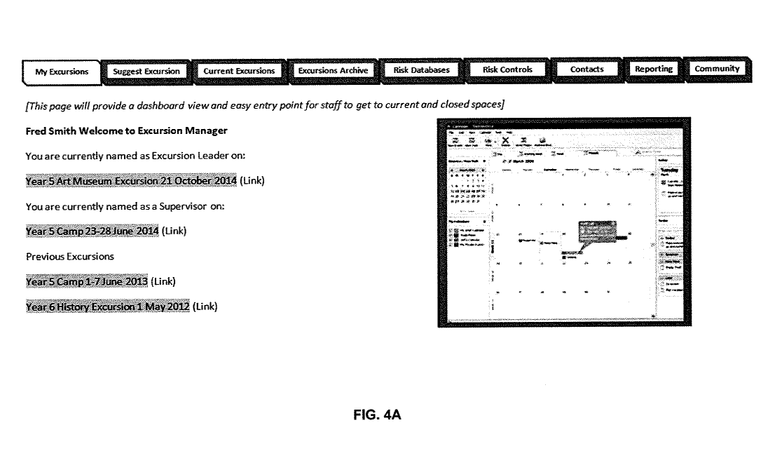

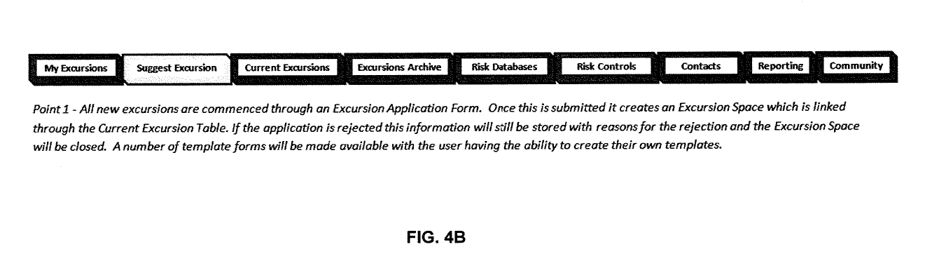

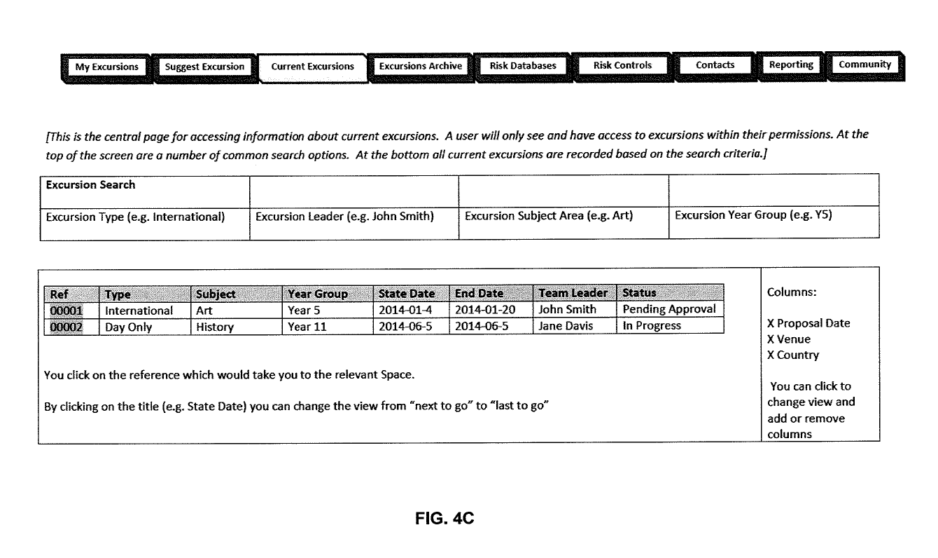

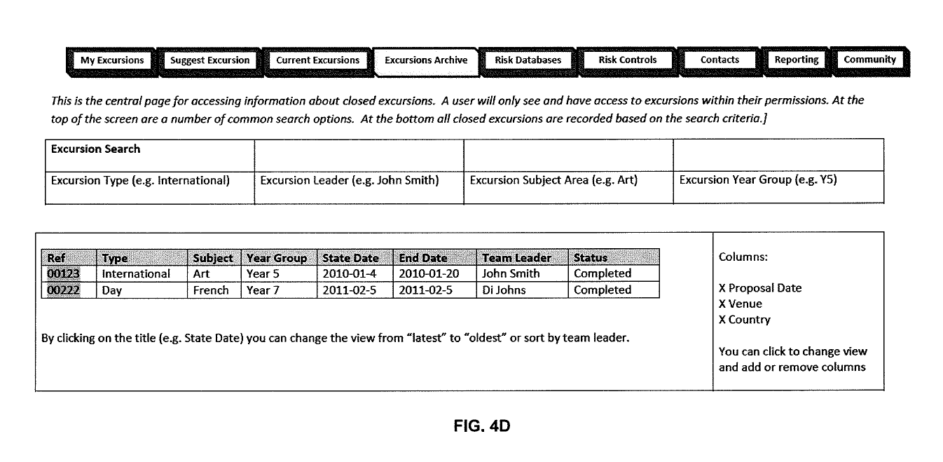

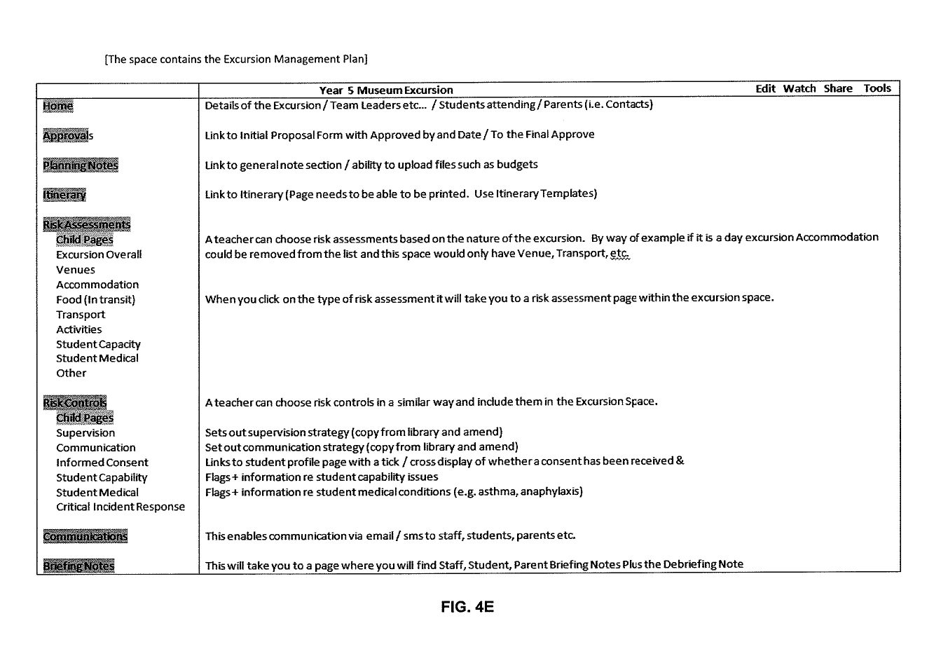

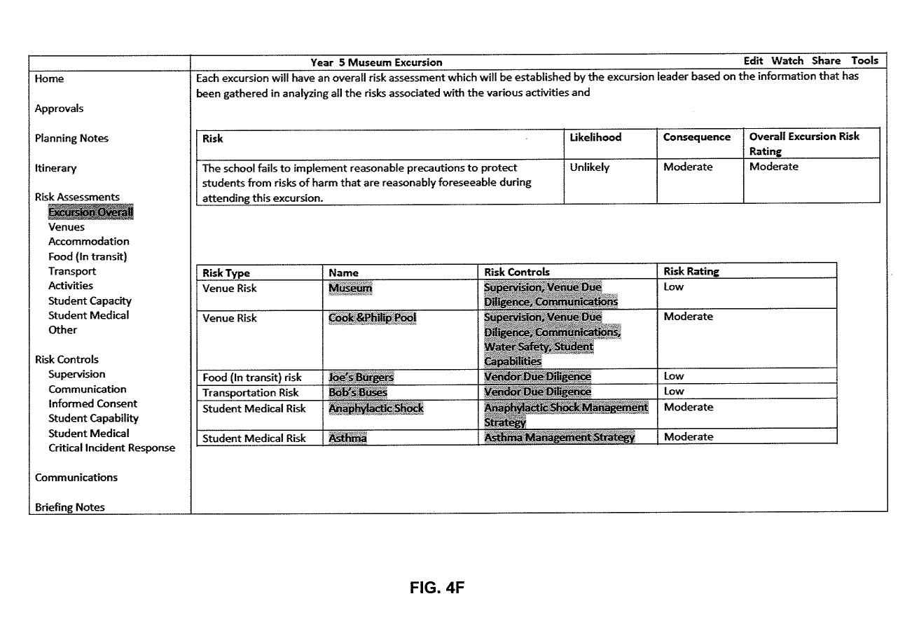

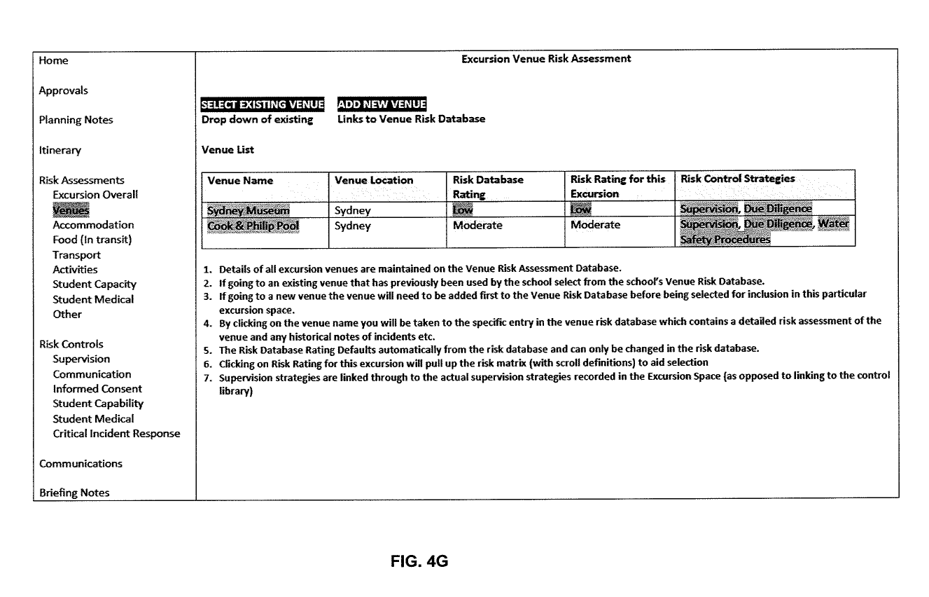

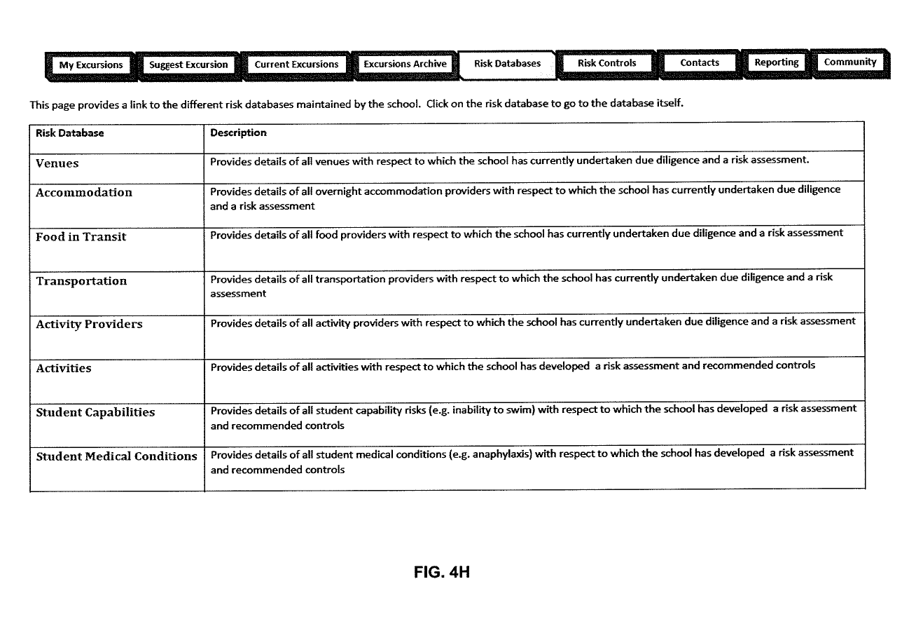

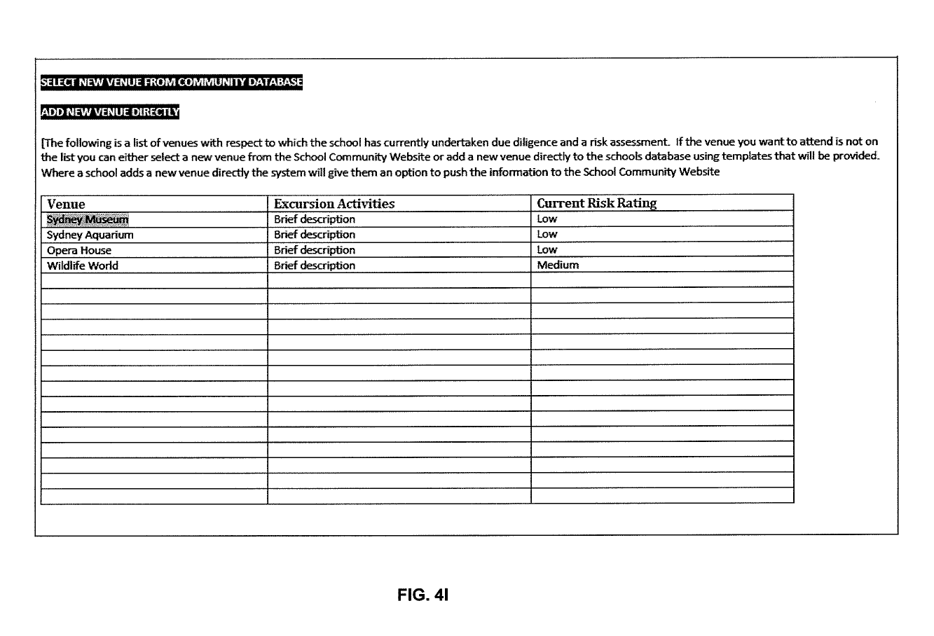

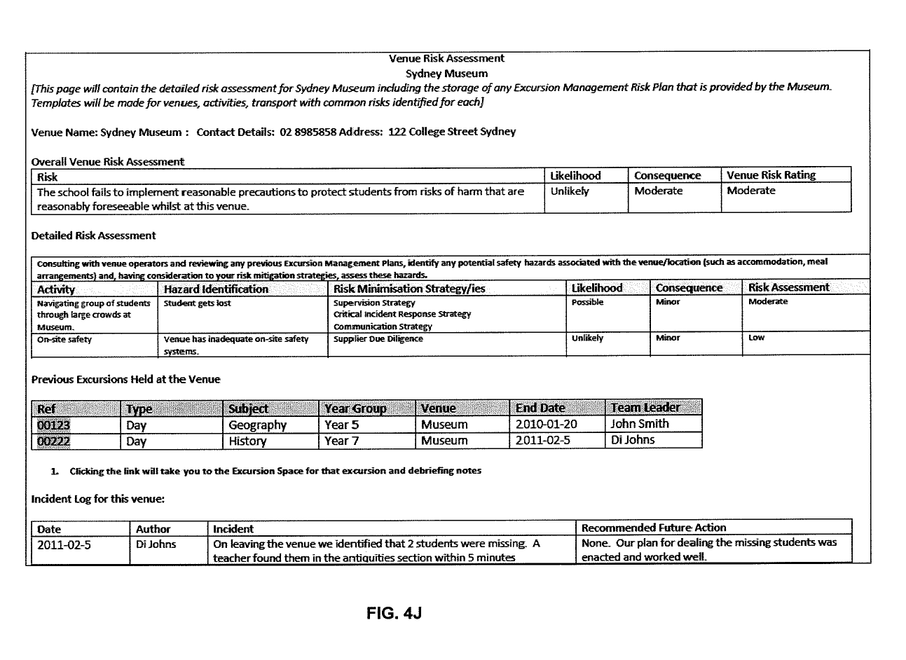

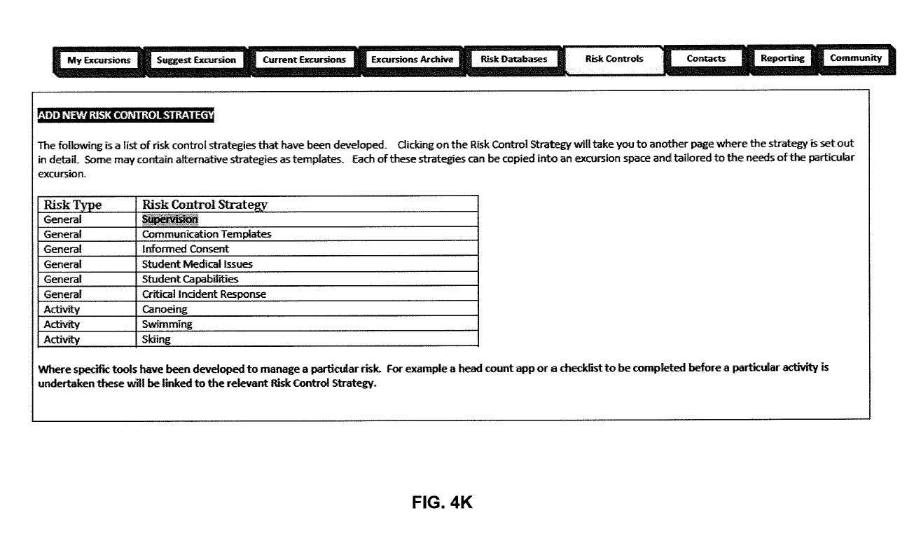

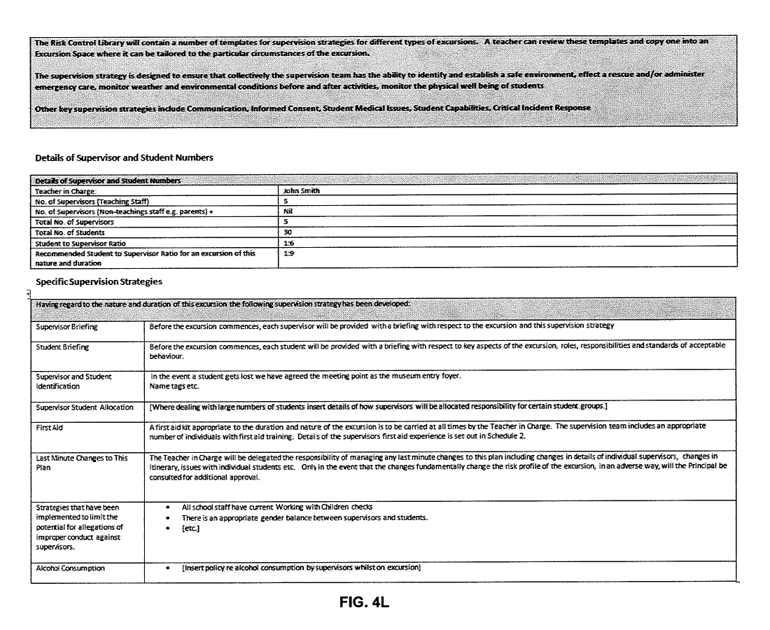

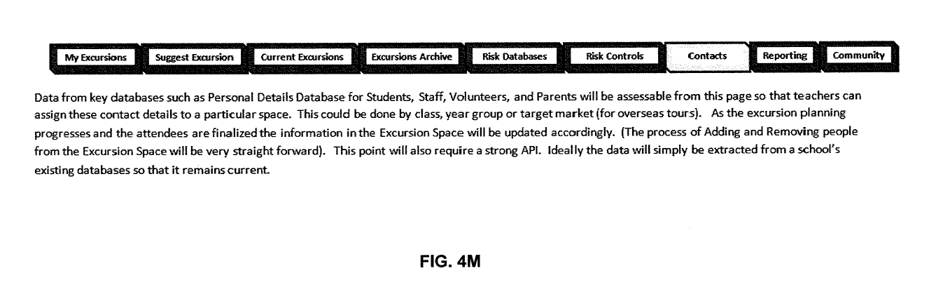

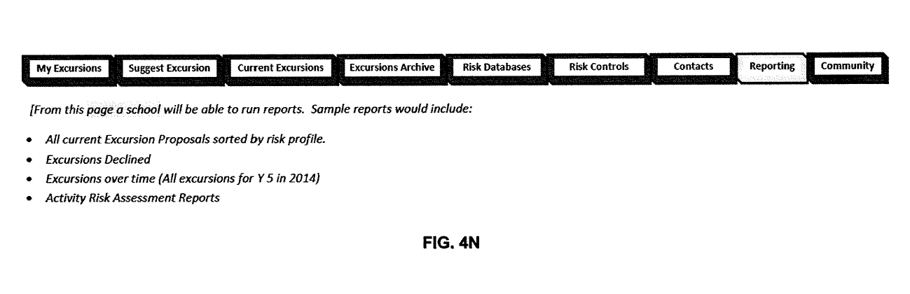

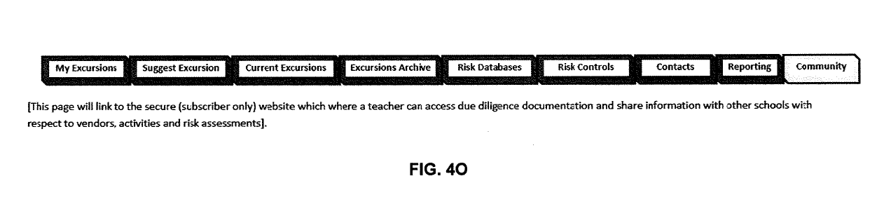

FIG. 4A to FIG. 4O provide exemplary screenshots for an exemplary embodiment, which may use the framework of FIG. 1A for FIG. 1B.

### Exemplary Client-Server Framework

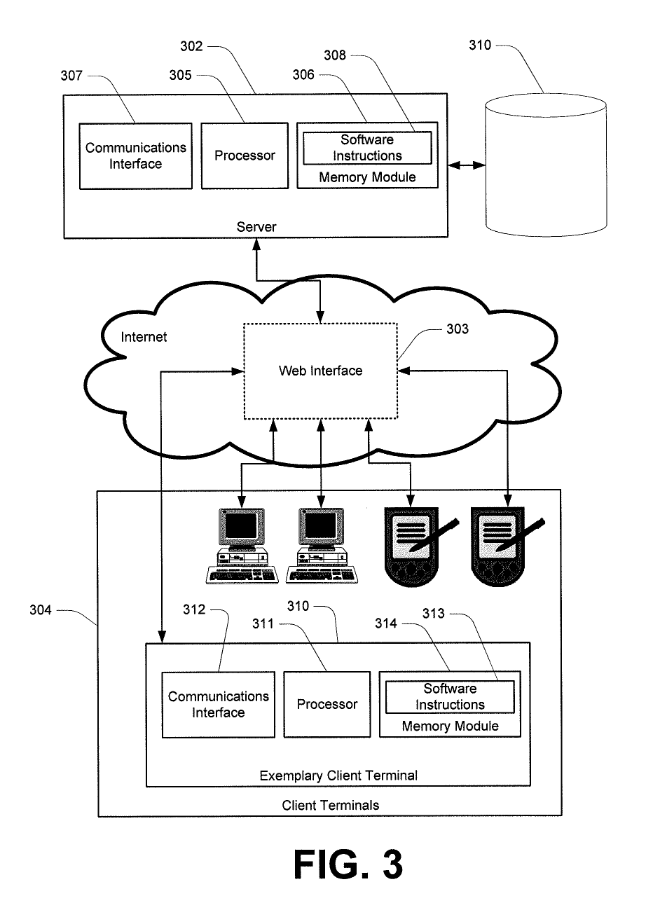

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for enabling management of organised activities, the method including:
providing a user interface that enables a user to generate an organised activity record for a proposed organised activity;
enabling the user to access a repository of organised activity items, wherein at least a selection of the organised activity items are each associated with data indicative of risk management policy data;
enabling the user to associate one or more of the organised activity items with the organised activity record; and
providing an interface that allows a further user to view the organised activity record, and thereby view the risk management policy data for the one or more organised activity items associated with the organised activity record.

2. A method according to claim 1 wherein each of the one or more organised activity items associated with the organised activity record are associated with supervisor guideline data, and wherein the method include outputting a representation of the supervisor guideline data for the organised activity record thereby to assist an organised activity supervisor in implementing risk management policies of the risk management policy data during the organised activity.

3. A method according to claim 2 wherein the representation includes one or more checklists.

4. A method according to claim 1 wherein the repository of organised activity items includes items customised from templates.

5. A method according to claim 1 wherein the repository of organised activity items includes items representing services, activities and/or venues provided by a service provider, wherein those items customised from templates by or on behalf of the service provider.

6. A method according to claim 1 wherein the organised activity items include organised activity items representing participants for the proposed organised activity.

7. A method according to claim 6 wherein an organised activity items for a given participant includes risk management policy data for a medical condition associated with the given participant.

8. A method according to claim 1 including providing a service provider interface configured to allow a service provider to generate and/or modify one or more organised activity items, where the generate and/or modified items are stored in the repository.

9. A method according to claim 1 including enabling the user to initiate a permission approval request process, thereby to provide data indicative of the organised activity records to addresses associated with participant guardians.

10. A method according to claim 9 wherein the method includes receiving and processing responses from the participant guardians thereby to maintain a record of received permission approvals.

11. A computer implemented method for enabling management of organised activities, the method including:
providing an application interface that is configured to enable the generation of a new organised activity application;
maintaining an organised activity register that provides access to an organised activity space for each of a plurality of organised activity records, wherein an organised activity record is generated responsive to a new organised activity application generated via the application interface;
via the organised activity space, providing access to complete an organised activity workflow process, wherein the organised activity workflow process is defined by a plurality of interactive sub-processes.

12. A method according to claim 11 wherein the organised activity workflow enables a user to select an organised activity item from a repository of organised activity items, selectively customise that item, and associate that item with given organised activity record.

13. A method according to claim 12 wherein each organised activity workflow item is associated with predefined risk management policy data, and predefined organised activity supervisor guideline data.

14. A method according to claim 12 wherein one or more of the organised activity items are defined by service providers via a service provider interface.

15. A method according to claim 11 wherein each organised activity record is accessible via its organised activity space by a plurality of users, wherein each user has a user category and a user permission set.

16. A method according to claim 11 including maintaining access to a repository of user records.

17. A method according to claim 16 wherein a given user, upon accessing a given organised activity record via its organised activity space, is provided with access to functionalities and/or information responsive to the user's user category and user permission set.

18. A method according to claim 11 wherein the plurality of interactive sub-processes include one or more sub-processes that are configured to be completed by a first category of user, and one or more sub-processes that are configured to be completed by a second category of user.

19. A method according to claim 11 wherein the plurality of interactive sub-processes include at least a selection of the following: initial approval; planning/risk assessment; formal approval; guardian consent procurement; student briefing; staff briefing; and debriefing.

20. A method according to claim 11 including providing a consent interface that enables a user to identify as a guardian in respect of a given student, and provide consent in respect of a given organised activity record.

21. A computer implemented method for enabling management of student organised activities, the method including:
providing an interface that is accessible by a plurality of user categories;
maintaining an organised activity register that provides access to an organised activity space for each of a plurality of organised activity records, wherein an organised activity record is generated responsive to a new organised activity application generated via the application interface;
via the organised activity space, providing access to complete an organised activity workflow process, wherein the organised activity workflow process is defined by a plurality of interactive sub-processes, including one or more sub-processes respectively configured to be conducted by users of each of the plurality of user categories.

22-33. (canceled)
